(19) United States
(12) Patent Application Publication
(10) Pub. No.: US 2005/0059312 A1
(43) Pub. Date: Mar. 17, 2005

(54) Method for producing a flat discharge lamp having spacers

(75) Inventor: Ahmet Oran, Giengen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 10/935,224

(22) Filed: Sep. 8, 2004

(30) Foreign Application Priority Data
Sep. 17, 2003 (DE) 103 43 073.3

(51) Int. Cl. H01J 9/00; H01J 9/24

(52) U.S. Cl. 445/24; 445/22; 445/26

(57) ABSTRACT

The method according to the invention proposes that the spacers (3) are dipped in a solder bath before the components of the flat discharge lamp are joined and are then arranged on the inner side of the base plate (6) of the discharge lamp such that the spacers (3) adhere to the inner side of the base plate (6) by means of the solder paste (5). As a result, the spacers (3) are secured against falling over in the subsequent manufacturing steps, in particular even during the joining process in the joining furnace.

### TECHNICAL FIELD

The invention relates to a method for producing a flat discharge lamp, also referred to below as a flat lamp, for short.

In particular, the invention is based on the production of flat lamps which are designed for dielectrically impeded discharges, i.e. in which at least the electrodes of one polarity are isolated from the discharge medium in the interior of the discharge vessel by means of a dielectric layer. Lamps of this type are also known as dielectric barrier discharge lamps.

Lamps of this type are suitable not only for general lighting but also, inter alia, for backlighting in liquid crystal displays (LCDs) as well as for decorative and advertising purposes.

### BACKGROUND ART

Flat lamps of the generic type have a discharge vessel which is formed by a base plate, a cover plate and a frame arranged between said plates. Otherwise, in this case the technology for flat lamps for dielectrically impeded discharges is assumed to be that known from the prior art. By way of example, reference is also made to the document U.S. Pat. No. 6,034,470.

The document U.S. Pat. No. 6,659,828 B1 discloses a flat discharge lamp of the generic type. The discharge vessel of this flat lamp comprises two parallel plates, a frame and spacers which space apart the two plates from one another. Each spacer comprises a component having a high viscosity at the joining temperature and a low-viscosity component. Before the discharge vessel is joined together, the respective vertical dimension of each spacer is greater than the envisaged final spacing between the two plates. The circumferential, crack-like opening which is initially held open thereby acts as a pump or filling opening in the discharge vessel. The respective low-viscosity component of each spacer compensates for any possible local deviations in the spacings between the two plates when the discharge vessel is joined together. One disadvantage here is the high manufacturing complexity associated with the two-part spacers. In addition, it may come to pass that a spacer which is a little too short to be clamped between the plates tips over prior to joining owing to the convection current in the joining furnace, which results in rejects.

### DISCLOSURE OF THE INVENTION

The object of the present invention is to avoid the abovementioned disadvantages and to specify an improved method for producing flat discharge lamps.

This object is achieved by a method for producing a flat discharge lamp, in particular a flat dielectric barrier discharge lamp, whose discharge vessel has a base plate, a cover plate and a frame as well as at least one spacer between the base plate and the cover plate and is filled with a discharge medium, comprising the following method steps: providing a solder bath, dipping one end of the at least one spacer in the solder bath, applying the dipped-in end of the at least one spacer to the inner side of the base plate such that the at least one spacer adheres to the inner side of the base plate by means of the solder paste from the solder bath.

The solder bath comprises a suitable solder paste, in particular a glass solder paste. Suitable glass solder pastes are low-melting glass solders mixed with a binder, for example lead borosilicate, zinc borate or else bismuth-based glass solders.

The method according to the invention offers, inter alia, the advantage that the spacers adhere to the base plate merely by means of the solder paste, i.e. before the solder has melted, with the result that they are prevented from falling over in the subsequent manufacturing steps. This is because, when the spacers are placed on the base plate, the solder paste forms a thin film in the respective contact region between the spacer and the base plate, with the result that the spacers adhere to the base plate by means of capillary adhesion.

In addition, the spacers, which are high in number in the case of large-area lamps (for example 288 spacers in the case of a lamp having a diagonal of 21.3 inches), are preferably all, in a common method step, dipped in the solder bath and then, in a further method step, applied to the base plate. For this purpose, a large number of spacers are in each case received and fixed at one end in an arrangement plate, for example by being sucked on, temporarily dipped in the solder bath in each case at the other end, then positioned over the base plate and finally released from the arrangement plate, for example by being blown out, such that, finally, the spacers adhere to the base plate, in each case with the end which was dipped in the solder bath. For this purpose, the arrangement plate is provided with corresponding depressions for receiving the spacers. In addition, the arrangement of the depressions in the arrangement plate must correspond to the envisaged positions for the spacers on the base plate.

Prior to joining in the joining furnace, the preassembled construction is provided with a cover plate and a surrounding frame which is arranged between the base plate and the cover plate. A few solder tablets are arranged between the frame and the cover plate for the purpose of forming a pump gap. Said solder tablets soften when the joining temperature is reached and close the base plate including the spacers with the frame and the cover plate with respect to the actual discharge vessel of the flat discharge lamp.

In one variant, the preassembled construction is introduced to the joining furnace with such an orientation that the inner side of the base plate points downward and, as a consequence, the spacers are suspended downward. This has the advantage that the spacers can still be aligned at right angles during joining and can then provide a planar bearing surface for the cover plate, since the glass solder paste at the ends of the spacers melts. During joining, moreover, minimum differences in height may be compensated for, since the glass plates soften slightly at the joining temperature, and, owing to the low pressure in the lamp, the spacers are finally pressed flush against the glass plates.

In principle, different forms for the spacers may be considered, but preferably cylindrical forms, in particular having a circular cross section.

In order not to complicate the above explanation of the invention unnecessarily, no description has been given of the manufacturing steps known per se relating to the electrodes of the flat lamp. In addition, the electrodes in any case play a subordinate role for the invention.

### BRIEF DESCRIPTION OF THE DRAWINGS

The invention will be explained in more detail below with reference to an exemplary embodiment. In the figures:

FIG. 1a shows an arrangement plate for receiving spacers,

FIG. 1b shows the arrangement plate shown in FIG. 1a having spacers inserted,

FIG. 2a shows a side view of a base plate of a flat lamp having spacers fitted on,

FIG. 2b shows a plan view of the base plate having the spacers shown in FIG. 2a fitted on,

FIG. 2c shows the base plate shown in FIG. 2a with the preassembled frame and cover plate, and

FIG. 2d shows the flat lamp which is completely joined together as shown in FIG. 2c.

### BEST MODE FOR CARRYING OUT THE INVENTION

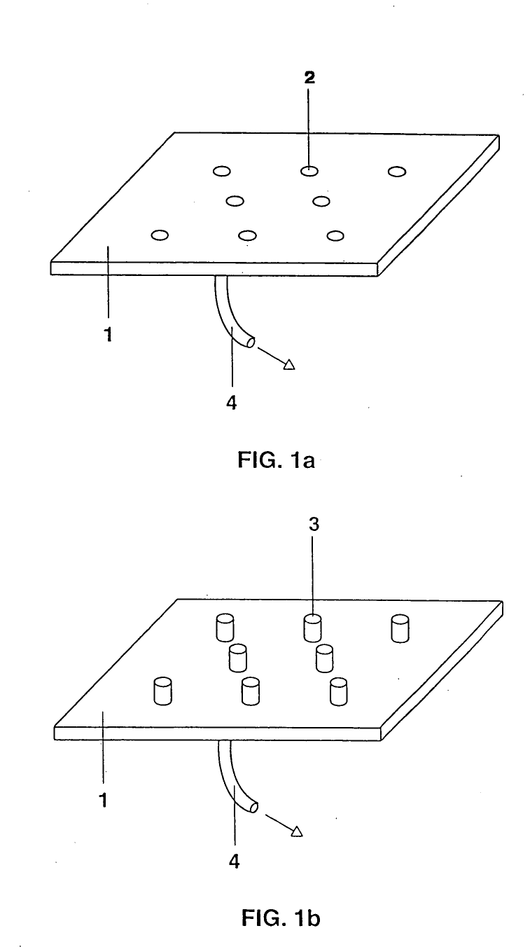

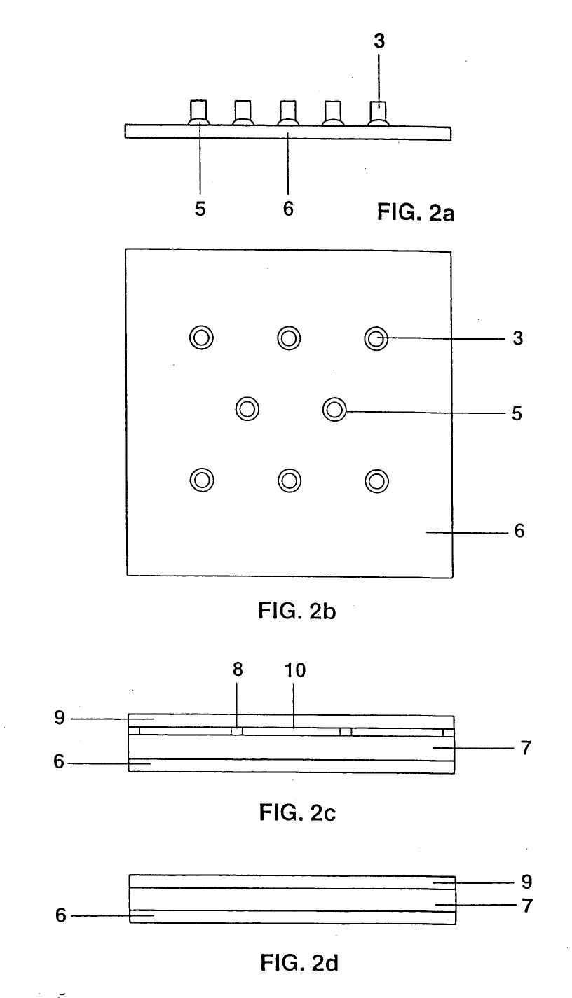

For the purpose of explaining the manufacturing steps according to the invention of a flat, dielectric barrier discharge lamp, reference is made below to FIGS. 1a, 1b and 2a-2d. In this case, the same features in the figures are provided with the same reference numerals. No more details are given here of the manufacturing steps previously required per se such as the application of the electrode paths, the dielectric barrier layer and the fluorescent layer, since they are irrelevant for understanding the invention (and are therefore not illustrated here for the sake of simplicity). Otherwise, reference is also made to the document already mentioned initially U.S. Pat. No. 6,034,470. FIG. 1a shows, by way of example, a rough schematic illustration of an arrangement plate 1 made of aluminum having only (for the sake of clarity) eight circular depressions 2 for receiving likewise eight cylindrical spacers 3 (see FIG. 1b). At this point it should be noted that, depending on the size of a flat lamp, considerably more spacers are required. For example, 288 spacers are required for a lamp having a diagonal of 21.3″. The spacers 3, which are approximately 4.3 mm in length, are inserted in the depressions 2 and drawn on by means of a tube 4 which is connected to the arrangement plate 1 and to a suction or compressed-air device (not shown). By this means, the arrangement plate 1 including the spacers 3 can be rotated without the spacers 3 falling out of their depressions 2. The arrangement plate 1 including the spacers 3 is then brought over a bath comprising glass solder Al 10104 such that the free ends of the spacers 3 dip into the solder bath (not shown). The arrangement plate having the spacers is then positioned over the glass base plate of the discharge lamp such that those ends of the spacers that have been wetted with glass solder are just over the surface of the base plate. The spacers are then released from the arrangement plate by being blown out and pressed onto the base plate. The spacers 3 then adhere to the base plate 6 by means of the glass solder paste 5 and can no longer fall over in the subsequent manufacturing steps. In order to complete the flat discharge vessel of the lamp, a surrounding frame 7 is applied to the base plate 6 by means of glass solder, in each case two glass solder tablets 8 and then finally a glass cover plate 9 being applied to each of the four sides of the frame 7. The in total eight glass solder tablets 8, which are approximately 2.4 mm high, serve the purpose of initially creating a gap 10 between the frame 7 and the cover plate 9. As a positive side effect, the cover plate 9 coated on its inner side with fluorescent material (not shown) no longer touches the spacers 3 (not visible in FIG. 2c), for which reason this fluorescent layer can also no longer be scratched during assembly. The entire preassembled construction is then brought into an evacuable joining furnace (not shown). After rinsing, baking and filling with the discharge gas, for which the abovementioned gap 10 is used, the temperature in the joining furnace is increased until the glass solder tablets 8 melt and the frame 7 with the base plate 6 and the cover plate 9 are sealed to form a gas-tight discharge vessel (see FIG. 2d). Alternatively, the preassembled construction may also be introduced to the joining furnace the opposite way up, i.e. with the spacers being suspended downward. This has the advantage that the spacers can still be aligned at right angles during joining and can then provide a planar bearing surface for the cover plate, since the glass solder paste at the ends of the spacers melts when the joining temperature is reached.

In any case, the method according to the invention has the advantage that the spacers can no longer tip over in the convection current of the joining furnace by virtue of the adhesion on the base plate by means of glass solder paste. As a result, the number of rejects can be reduced.

1. A method for producing a flat discharge lamp, in particular a flat dielectric barrier discharge lamp, whose discharge vessel has a base plate, a frame and a cover plate as well as at least one spacer between the base plate and the cover plate and is filled with a discharge medium, comprising the following method steps:
providing a solder bath comprising solder paste,
dipping one end of the at least one spacer in the solder bath,
applying the dipped-in end of the at least one spacer to the inner side of the base plate such that the at least one spacer adheres to the inner side of the base plate by means of the solder paste from the solder bath.

2. The method as claimed in claim 1, in which a large number of spacers are in each case
received and fixed at one end in an arrangement plate,
temporarily dipped in the solder bath at the other end,
applied to the base plate at the end which was dipped in the solder bath, and finally
released from the arrangement plate.

3. The method as claimed in claim 2, in which the spacers are fixed in the arrangement plate by being sucked on.

4. The method as claimed in claim 2, in which the spacers are released from the arrangement plate by being blown out.

5. The method as claimed in claim 1, in which at least one interspace is initially held open as the filling opening between the cover plate and the frame.

6. The method as claimed in claim 5, in which the interspace is realized by one or more solder tablets being arranged between the frame and the cover plate.

7. The method as claimed in claim 1, in which the longitudinal extent of the at least one spacer at right angles to the base plate essentially corresponds to the final spacing between the inner sides of the base plate and the cover plate.

8. The method as claimed in claim 1, in which the base plate having the at least one spacer, the frame and the cover plate are joined in an evacuable furnace to form the discharge vessel.

9. The method as claimed in claim 8, in which the furnace is filled with the discharge medium during the joining process.

10. The method as claimed in claim 8, in which the preassembled construction comprising the base plate having the at least one spacer, the frame and the cover plate is introduced to the joining furnace with such an orientation that the inner side of the base plate points downward and, as a consequence, the at least one spacer is suspended downward.

11. The method as claimed in claim 1, in which the discharge vessel has discharge electrodes which are at least partially isolated from the discharge medium in the interior of the discharge vessel by means of a dielectric layer.

12. The method as claimed in claim 11, in which the electrodes are in the form of electrode paths arranged on the base plate of the discharge vessel.

13. The method as claimed in claim 1, in which the solder bath comprises a low-melting glass solder, for example lead borosilicate, zinc borate or else a bismuth-based glass solder.

14. The method as claimed in claim 9, in which the preassembled construction comprising the base plate having the at least one spacer, the frame and the cover plate is introduced to the joining furnace with such an orientation that the inner side of the base plate points downward and, as a consequence, the at least one spacer is suspended downward.
